(19) United States
(12) Patent Application Publication
(10) Pub. No.: US 2019/0212877 A1
(43) Pub. Date: Jul. 11, 2019

(54) SELECTIVELY DISPLAYABLE MULTIPLE DISPLAY MODE FOR A GUI

(71) Applicant: Microsoft Technology Licensing, LLC, Redmond, WA (US)

(72) Inventors: Jeffrey SIPKO, Kirkland, WA (US); Christian M. SADAK, Seattle, WA (US); Aaron D. KRAUSS, Seattle, WA (US); John Benjamin HESKETH, Kirkland, WA (US); Timothy D. KVIZ, Seattle, WA (US)

(73) Assignee: Microsoft Technology Licensing, LLC, Redmond, WA (US)

(21) Appl. No.: 15/867,642

(22) Filed: Jan. 10, 2018

(51) Int. Cl. G06F 3/0481; G06F 3/14; G06F 1/16; G09G 5/14

(52) U.S. Cl. CPC G06F 3/0481; G06F 3/1446; G06F 1/1641; G09G 2340/14; G09G 5/14; G06F 1/1681; G09G 2354/00; G06F 1/1647

(57) ABSTRACT

A computing device is provided that includes a primary display and a secondary display operatively coupled to a processor. The processor may be configured to execute an application program that has a GUI with a single display mode and a selectively displayable multiple display mode. The multiple display mode may include at least a primary view and a secondary view. In a single display mode, the processor may be configured to initially display the GUI on the primary display and not display the GUI on the secondary display. Upon receiving a multidisplay command to display the GUI in the multiple display mode, the processor may transition the application to the multiple display mode in which the primary view is displayed on the primary display, and the secondary view is displayed on the secondary display.

### BACKGROUND

Computing devices with multiple displays allow users to view application programs and digital content across a broader display area. While such setups are a convenient platform for viewing content of the application program in a larger format, having multiple displays connected to the computing device can be challenging in several ways. Displaying the application program on more than one display may result in a discontinuous appearance, as the application program may lack awareness of text breaks and other features of how the program is displayed. When creating or editing an image in a graphics application program across multiple displays, tool bars and panels may be disrupted or otherwise not easily accessible. When using multiple displays to view and play a gaming application program, the seam between the displays may obscure or break up relevant content, resulting in a deterioration of the gaming experience. When viewing an email application on more than one display, the message window may be separated by a gap between the displays, making it difficult to read a message or compose a reply. Such disruption of content may be jarring for the user to view, and the inability to logically separate various content of the application into different windows across multiple displays may be frustrating to the user.

### SUMMARY

To address the above issues, a computing device is described herein that includes a processor, a primary display, and a secondary display. The primary display and the secondary display may each be operatively coupled to the processor. The processor may be configured to execute an application program that has a graphical user interface (GUI). The GUI may have a single display mode and a selectively displayable multiple display mode that includes at least a primary view and a secondary view. In a single display mode, the processor may be configured to initially display the GUI on the primary display and not display the GUI on the secondary display. When the processor receives a multidisplay command to display the GUI in the multiple display mode, the processor may transition the application to the multiple display mode in which the primary view is displayed on the primary display, and the secondary view is displayed on the secondary display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of an example computing device according to the present disclosure.

FIGS. 2A-2C show the computing device of FIG. 1 transitioning from the single display mode of a GUI to the multiple display mode of the GUI.

FIG. 3 shows the computing device of FIG. 1 configured as a desktop computing device with two external displays.

FIG. 4 shows the computing device of FIG. 1 configured as a mobile computing device with an integrated display and an external display.

FIGS. 5A-5D show the computing device of FIG. 1 configured as a hinged mobile computing device with two integrated displays arranged in a variety of angular orientations from back-to-back to face-to-face.

FIG. 6 shows the hinged mobile computing device of FIG. 5 with the first and second displays arranged in a side-by-side orientation.

FIG. 7 shows the computing device of FIG. 3 with four external displays.

FIG. 8 shows a flowchart of a method for a computing device, according to one implementation of the present disclosure.

FIG. 9 shows an example computing system according to one implementation of the present disclosure.

### DETAILED DESCRIPTION

The inventors of the subject application have discovered that viewing content of a computer application program on more than one display is constrained by the lack of ability of conventional systems to intelligently organize the contents of application programs across multiple displays. In a typical configuration, displaying the application program across multiple displays may result in a visual and/or informational disruption of content. Conventional computing devices often display additional information relevant to the application program as icons in a tool bar or a preview button, which can be time-consuming for the user to find and utilize when the tool bar or preview button is spanning a gap between displays. Additionally, the user may be required to open a new window within the application program to view and select a desired option, and such windows may further obscure the main window of the application program, which is already spanning the gap and difficult to view by the user.

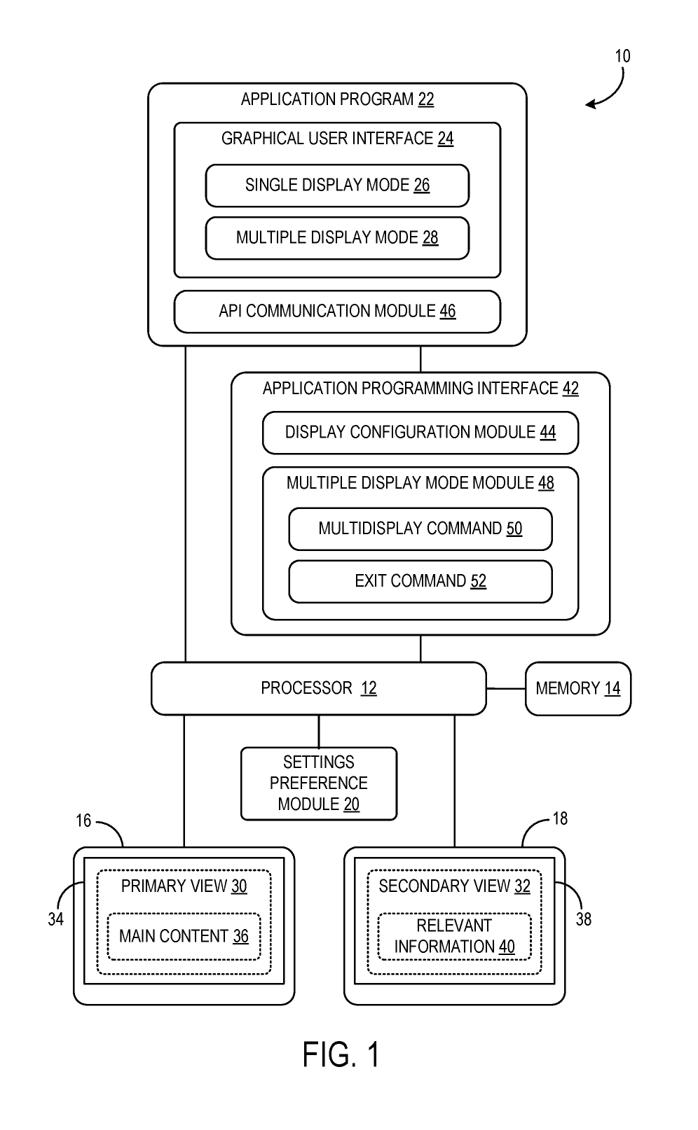

As schematically illustrated in FIG. 1, to address the above identified issues a computing device 10 is provided. The computing device 10 may include a processor 12 with associated memory 14, and at least two displays. The displays may be configured as a primary display 16 and a secondary display 18, and each display 16, 18 may be operatively coupled to the processor 12. While the primary display 16 is generally understood to be the central focal display for a user, it will be appreciated that the arrangement of the displays 16, 18 and their designations as the primary display 16 and the secondary display 18 may be determined by the user in a settings preference module 20 executed by the processor 12.

The processor 12 may be configured to execute an application program 22 installed on the computing device 10. The application program 22 may have a graphical user interface (GUI) 24 that may include a single display mode 26 and a selectively displayable multiple display mode 28. The single display mode 26 may display a launch window 27 of the GUI 24 of the application program, as described below. The multiple display mode 28 of the GUI 24 may include at least a primary view 30 and a secondary view 32. When the GUI 24 is viewed in the multiple display mode 28 as indicated by the dashed lines in FIG. 1, the primary view 30 may be displayed in a first window 34 on the primary display 16 and include all or a subset of content of a launch window 27 of the GUI 24, herein referred to as a main content 36. Accordingly, the secondary view 32 may be displayed in a second window 38 on the secondary display 18 and include a subset or none of the content of the launch window 27 of the GUI 24, herein referred to as information 40 relevant to the main content 36.

The launch window 27 may be a window that is displayed in the single display mode 26 upon the launching of the applicant program 22, such as the file named main.exe, for example. The multiple display mode 28 allows the GUI 24 of the application program 22 to be displayed on at least the primary and secondary displays 16, 18 in separate windows 34, 38. The primary view 30 in the first window 34 may display all or some of the content of the launch window 27, and the secondary view 32 in the second window 38 may display some or none of the content of the launch window 27. For example, the content of the launch window 27 may be separated into the main content 36 and relevant information 40 and displayed in both the primary and secondary views 30, 32, respectively. Alternatively, the primary view 30 may display the content of the launch window 27 as the main content 36 of the GUI 24 while the secondary view 32 displays relevant information 40 that is otherwise not displayed in the single display mode 26. Examples of the main content 36 of the primary view 30 and the contextually relevant information 40 of the secondary view 32 are discussed in detail below. While many of the embodiments described herein feature computing devices having two displays, it will be appreciated that, in some implementations, the computing device 10 may include one or more displays in addition to the primary display 16 and the secondary display 18.

The computing device 10 may further include an application programming interface (API) 42 in communication with the processor 12 and the application program 22. The application program 22 may be configured to query the API 42 to determine the total number of displays operatively coupled to the processor 12. The API 42 may include a display configuration module 44 that determines a total number of displays that are included in the computing device 10, as well as the arrangement of the displays. The API 42 may be further configured to recognize the capabilities of each display device, such as a keyboard or speaker, as well as relational information about each monitor with respect to the primary display 16. This information may be communicated by the API 42 to the application program 22 via an API communication module 46 included in the application program 22 to determine how to display the GUI 24 on the available displays. With an understanding of each monitor, its capabilities, and its orientation with respect to the primary display 16, the application program 22 can intelligently output the GUI 24 in a configuration that utilizes all of the monitors and their capabilities.

The API 42 may also include a multiple display mode module 48 that is configured to recognize user input and communicate a multidisplay command 50 to the processor 12 when the user desires to display the GUI 24 of the application program 22 in the multiple display mode 28. Similarly, the multiple display mode module 48 may recognize an exit command 52 from the user and communicate the exit command 52 to the processor 12 to cease displaying the GUI 24 in the multiple display mode 28 and return to the single display mode 26.

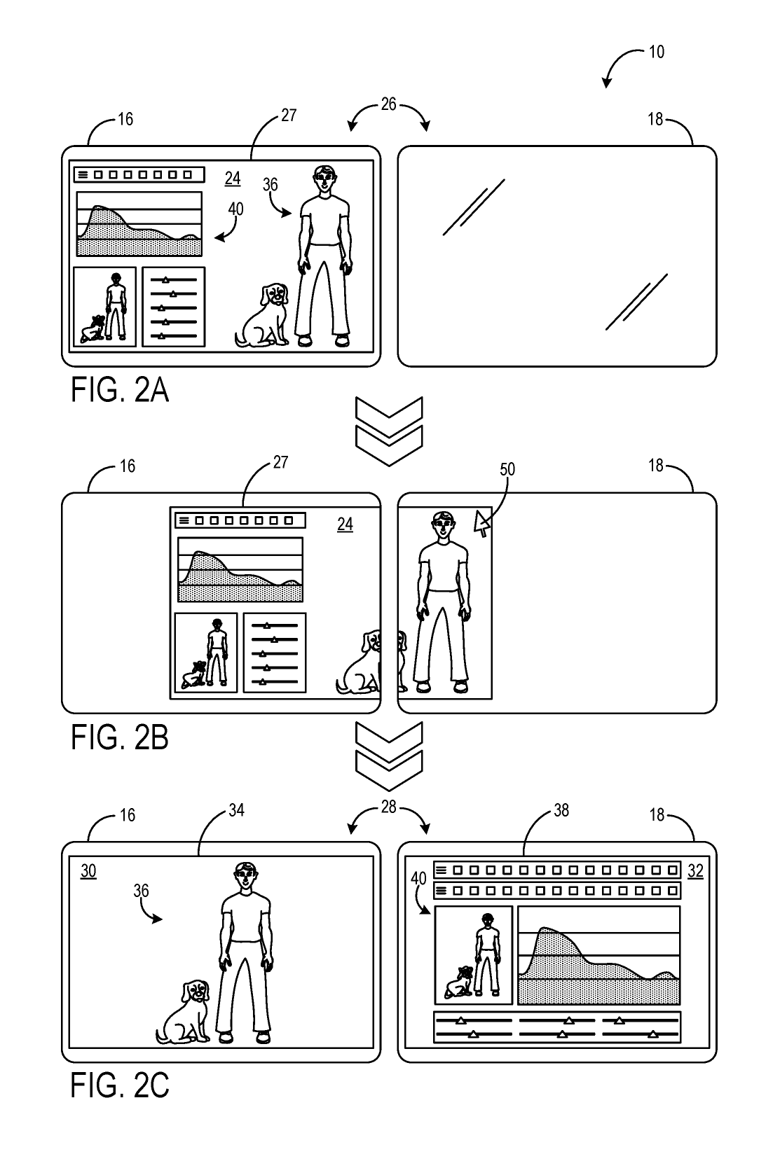

When executing an application program 22 with a GUI 24 that may be displayed in a single display mode 26 or a multiple display mode 28, the processor 12 may be configured to initially display the GUI 24 in a single display mode 26 on the primary display 16 and not display the GUI 24 on the secondary display 18. As discussed above, the processor 12 may be further configured to receive the multidisplay command 50 to display the GUI 24 in the multiple display mode 28. As described below with reference to FIG. 2, the multidisplay command 50 may be in the form of user input recognized by the API 42 and communicated to the processor 12. In response to receiving the multidisplay command 50, the processor 12 may transition the display of the GUI 42 to the multiple display mode 28, and display the primary view 30 on the primary display 16 and the secondary view 32 on the secondary display 18.

An example of the transition between the single display mode 26 and the multiple display mode 28 is provided in FIGS. 2A-2C. In the provided example, the computing device 10 includes two displays, which are indicated in FIGS. 2A-2C as the primary display 16 on the left and the secondary display 18 on the right. The processor 12 may execute the application program 22 that has a GUI 24, such as an image editing program. As shown in FIG. 2A, the processor 12 may initially display the GUI 24 in a single display mode 26 in which content is displayed in a single window on the primary display 16, and the GUI 24 is inhibited from being displayed, that is, is not displayed, on the secondary display 18. In the single display mode 26, according to the settings of the application program 22, the main content 36 of the GUI 24 and additional contextually relevant settings or information 40 may be displayed concurrently in the launch window 27 on the primary display 16, as shown in the left panel of FIG. 2A. Alternatively, some settings and information may be obscured from the main view and accessed via toolbars or other selectable buttons.

The user may desire to view the GUI 24 on both available displays 16, 18 and provide a multidisplay command 50 to enter the multiple display mode 28. The multidisplay command 50 to display the GUI 24 in the multiple display mode 28 may be communicated to the computing device 10 in several ways, such as keyboard input, pointer input, touch input from a digit, touch input from a stylus, electrical input from a switch, input from a remote device, and voice input. For example, as shown in FIG. 2B, the multidisplay command 50 may be input via a pointer (controlled by a mouse or the like) to select and drag the GUI 24 to the secondary display 18. While the position of the launch window 27 of the GUI 24 is straddling the primary and secondary displays 16, 18 such that at least a portion of the launch window 27 is visible in both displays, it will be appreciated that the view of the launch window 27 is distinguished from the primary and secondary views 30, 32, which are displayed in the first window 34 and the second window 38, respectively, when the GUI 24 is viewed in the multiple display mode 28.

When the pointer is released, the multidisplay command 50 may be recognized, and the GUI 24 will be displayed in the multiple display mode 28, as shown in FIG. 2C. A similar gesture may be input on a computing device 10 equipped with a touch-sensitive display, and the user may use touch input from the stylus or one or more fingers to drag the window on the primary display 16 into a viewable area on the secondary display 18 to activate the multiple display mode 28 of the GUI 24. Alternatively, the user may enter the multidisplay command 50 on a keyboard, in the form of a predetermined combination or sequence of keystrokes, for example. Some computing devices 10 may be equipped with an electrical switch, such as a tactile button, for example, and the user may enter the multidisplay command 50 by activating the switch. Additionally or alternatively, the computing device 10 may be in communication with a remote device, and the multidisplay command 50 may be entered via the remote device. On computing devices 10 equipped with voice recognition, the user may speak the multidisplay command 50 that directs the GUI 24 to be displayed in the multiple display mode 28.

As discussed above and shown in FIG. 2C, when displaying the GUI 24 in the multiple display mode 28, the primary view 30 on the primary display 16 may include the main content 36 of the GUI 24. In the example of the GUI 24 displayed in the multiple display mode 28 provided in FIG. 2C, the primary view 30 contains a subset of the content of the launch window 27 and shows an image that is being edited. The secondary view 32 displayed on the secondary display 18 may include a subset or none of the content of the launch window 27. In the illustrated example in FIG. 2C, image editing toolbars and a color saturation adjustment panel are provided as an example of information 40 relevant to the main content 36.

Similarly to entering the multidisplay command 50 to display the GUI 24 in the multiple display mode 28, the exit command 52 to stop displaying the GUI 24 in the multiple display mode 28 may be communicated to the computing device 10 in several ways, such as keyboard input, pointer input, touch input from a digit, touch input from a stylus, electrical input from a switch, input from a remote device, and voice input. Examples of such communication between the user and the computing device 10 are provided above with reference to the multidisplay command 50 to display the GUI 24 in the multiple display mode 28. The exit command 52 may take the same form as, or a reverse iteration of, the multidisplay command 50 to enter the multiple display mode 28.

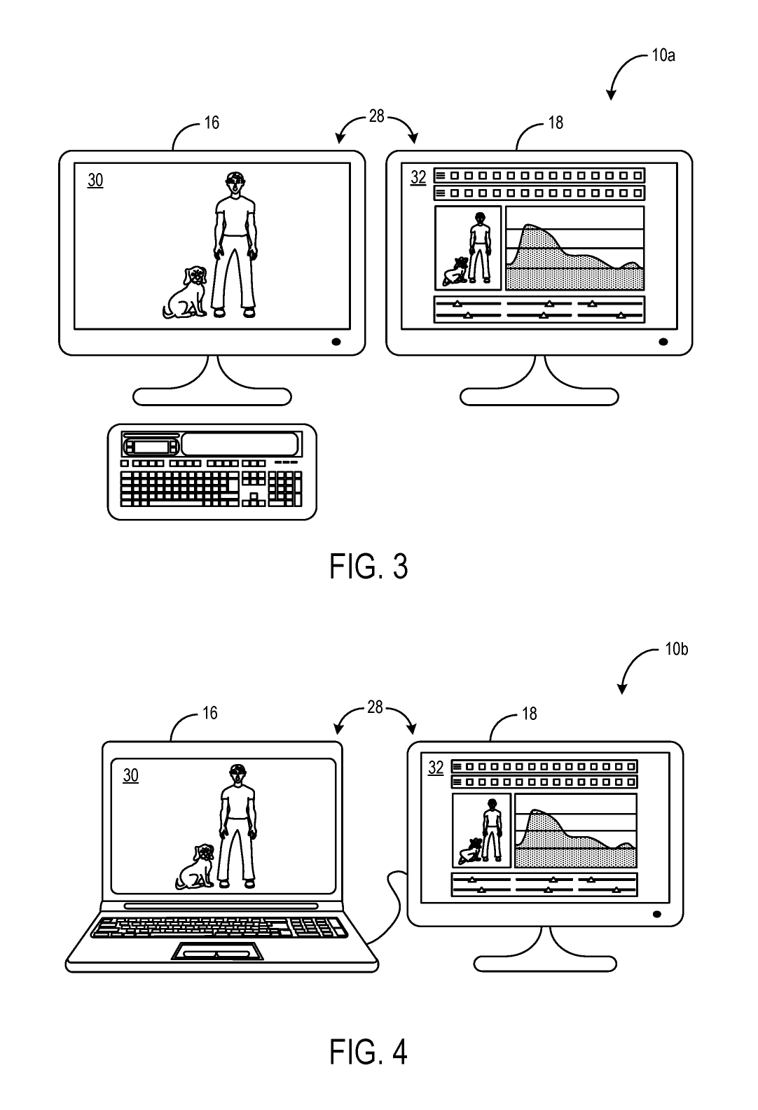

Turning now to FIG. 3, an example implementation of the computing device 10 is provided. FIG. 3 illustrates the computing device 10 is configured as a desktop computing device 10a in communication with two or more displays. In this example, the display in front of a keyboard may be configured as the primary display 16, and the display situated to the right, from the perspective of the user facing the primary display 16, may be configured as the secondary display 18. However, as discussed above, it will be appreciated that the arrangement of the displays 16, 18 and their designations as the primary display 16 and the secondary display 18 may be determined by the user. In the illustration of FIG. 3, the computing device 10a is in the multiple display mode 28, in which the primary view 30 is displayed on the primary display 16 and the secondary view 32 is displayed on the secondary display 18.

FIG. 4 shows an example implementation in which the computing device 10 is configured as a mobile computing device 10b with an integrated display, and is in communication with one or more external displays. In the example illustrated in FIG. 4, the mobile computing device 10b is illustrated as a laptop computer with an additional external display, but it will be appreciated that the mobile computing device 10b may, for example, take the form of a tablet computing device or another suitable mobile computing device. In this example, the display integrated into the mobile computing device 10b may be configured as the primary display 16, and the external display situated at the user's right may be configured as the secondary display 18. However, as discussed above, it will be appreciated that the arrangement of the displays 16, 18 and their designations as the primary display 16 and the secondary display 18 may be determined by the user. Like the example shown in FIG. 3, the mobile computing device 10b illustrated in FIG. 4 is in the multiple display mode 28, in which the primary view 30 is displayed on the primary display 16 and the secondary view 32 is displayed on the secondary display 18.

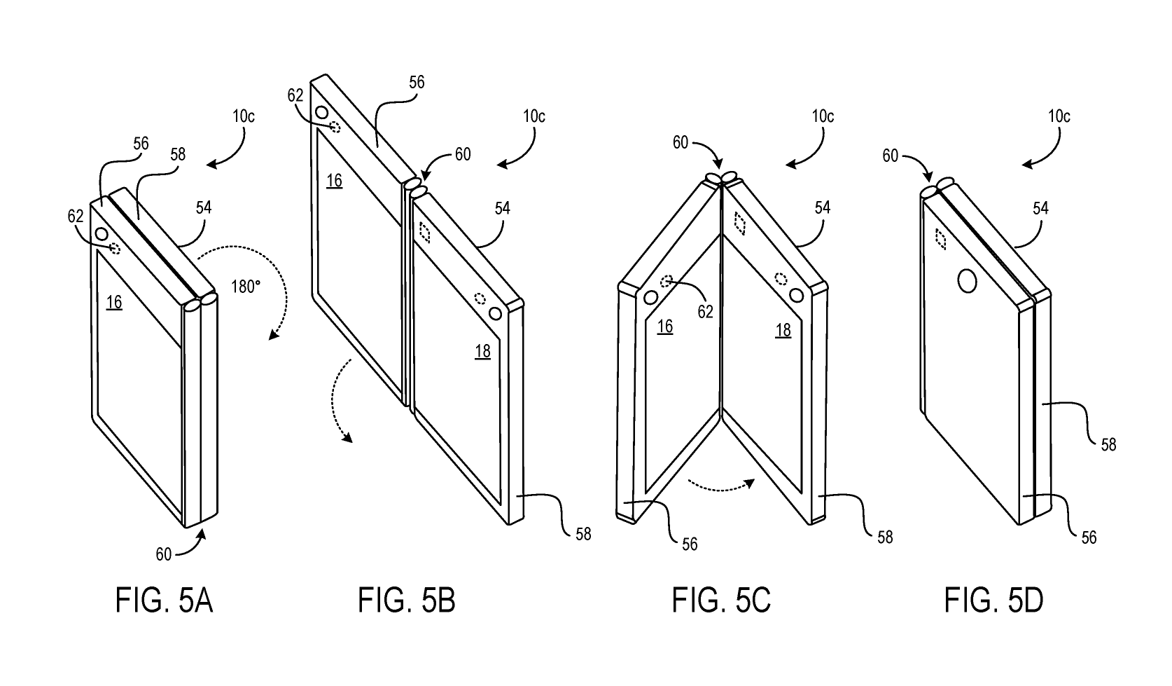

In another example implementation, the computing device 10 may be configured as a hinged mobile computing device 10c, as illustrated in FIGS. 5A-5D. The hinged mobile computing device 10c may include a housing 54, which, for example, may take the form of a casing surrounding internal electronics and providing structure for displays, sensors, speakers, buttons, etc. The housing 54 may have a first part 56 and a second part 58 coupled by a hinge 60. The first part 56 may include the primary display 16, and the second part 58 may include the secondary display 18. The hinge 60 may be configured to permit the primary and secondary displays 16, 18 to rotate between angular orientations from a face-to-face angular orientation to a back-to-back angular orientation. In this example, from the user's perspective when holding the hinged mobile computing device 10c in a side-by-side orientation as illustrated in FIG. 5B, the display situated on the left may be configured as the primary display 16, and the display situated on the right may be configured as the secondary display 18. However, as discussed above, it will be appreciated that the designation of the displays as the primary display 16 and the secondary display 18 may be determined by the user.

The hinged mobile computing device 10c may further include one or more sensor devices 62 mounted in the housing 54 that may be configured to measure the relative angular displacement between the first and second parts 56, 58 of the housing 54. As shown in FIGS. 5A-5D, the first and second parts 56, 58 of the housing 54 of the hinged mobile computing device 10c are illustrated in a variety of angular orientations. As described above, the hinge 60 permits the first and second parts 56, 58 of the housing 54 to rotate relative to one another such that an angle between the first and second parts 56, 58 can be decreased or increased by the user via applying suitable force to the housing 54 of the hinged mobile computing device 10c. The relative angular displacement is measured between an emissive side of each of the primary and secondary displays 16, 18. As shown in FIGS. 5A to 5D, the first and second parts 56, 58 of the housing 54 may be rotated in a range up to 360 degrees from a fully open back-to-back angular orientation, with respect to the primary and secondary displays 16, 18, as shown in FIG. 5A to a fully closed face-to-face orientation as shown in FIG. 5D. While the example implementation illustrates the first and second parts 56, 58 of the housing 54 rotating in a 360-degree orientation, it will be appreciated that alternate implementations of the hinged mobile computing device 10c may rotate through an angle range that is less than 360 degrees.

As described above, the user may desire to view the GUI 24 on both available displays of the hinged mobile computing device 10c and provide the multidisplay command 50 to enter the multiple display mode 28. Like the examples provided with reference to FIG. 2, the multidisplay command 50 to display the GUI 24 in the multiple display mode 28 may be communicated to the hinged mobile computing device 10c in several ways, as described above. Additionally, when the computing device 10 is implemented as a hinged mobile computing device 10c, the multidisplay command 50 to display the GUI 24 in the multiple display mode 28 may be based on a predetermined angle of the hinge 60. For example, the user may view the GUI 24 in the single display mode 26 when the hinged mobile computing device 10c is in a fully open orientation, as illustrated in FIG. 5A. Rotating the first part 56 or the second part 58 of the housing 54 around the hinge 60 to place the hinged mobile computing device 10c in a side-by-side orientation, as illustrated in FIG. 5B, may serve as the multidisplay command 50 that triggers the processor 12 to display the GUI 24 in a multiple display mode 28.

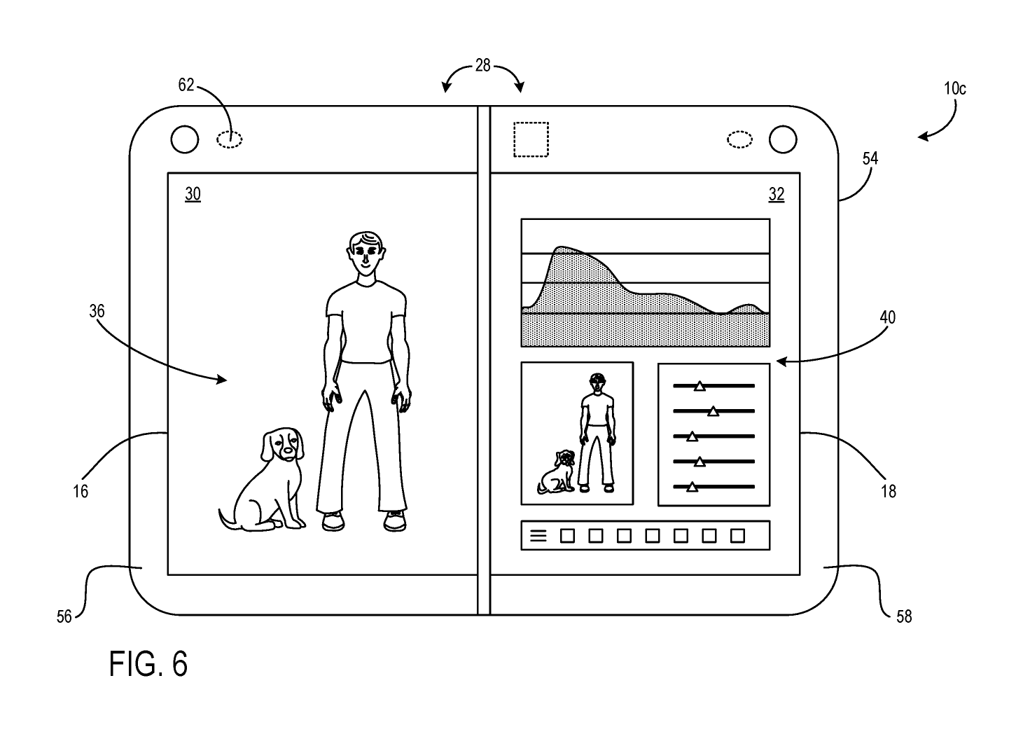

An example of the GUI 24 displayed in the multiple display mode 28 on the computing device 10 configured as a hinged mobile computing device 10c in a fully open orientation is provided in FIG. 6. While the hinged mobile computing device 10c is depicted with the primary and secondary displays 16, 18 in a side-by-side orientation, it will be appreciated that other suitable arrangements, such as a top-to-bottom orientation, may be used to display the GUI 24 in the multiple display mode 28. As discussed above, when displaying the GUI 24 in the multiple display mode 28, the primary view 30 on the primary display 16 may include all or a subset of the content of the launch window 27 of the GUI 24, i.e., the main content 36 of the GUI 24, and the secondary view 32 on the secondary display 18 may include a subset or none of the content of the launch window 27 of the GUI 24, i.e., relevant information 40 related to the main content 36. Typically, the main content 36 and relevant information 40 are different from each other, and also each is different in a respect from the originally presented content in the launch window for the application program. The main content 36 and relevant information 40 may alternatively be referred to as first content and second content.

In any of the examples illustrated herein of the GUI 24 displayed in the multiple display mode 28, the primary view 30 displays an image that is being edited, and the secondary view 32 provides the user with access to relevant information 40, such as image editing toolbars and a color saturation adjustment panel. However, it will be appreciated that any number of use-case scenarios may be applicable to the present disclosure.

For example, displaying the GUI 24 of an email application program in the multiple display mode 28 may provide main content 36 in the form of a reading pane for the currently accessed message on the primary display 16 and show relevant information 40 such as an email message inbox and/or contact information for the sender, for example, on the secondary display 18. Similarly, in a voice or video conference application program equipped with a GUI 24, a video or chat window may be displayed on the primary display 16, and a meeting agenda, contact information for other participants, and or notes may be displayed on the secondary display 18. When viewing the GUI 24 for a video or music editing application program in the multiple display mode 28, the primary display 16 may display the video or a visual readout of each element of the music clip as the main content 36, and the secondary display 18 may display tools for editing or mixing the video or music as relevant information 40 related to the main content 36.

When implemented on a hinged mobile computing device 10c, a book reading application program may display a page on each of the primary and secondary displays 16, 18, and rotating the displays 16, 18 around the hinge 60 to simulate opening and closing a book may trigger a function to virtually “turn” the pages displayed on the primary and secondary displays 16, 18. It will be appreciated that the use-case scenarios described herein are intended to be exemplary in nature, and that other types of application programs 22 not specifically mentioned above, such as maps, social media, and/or drawing programs, may also be implemented in the multiple display mode 28.

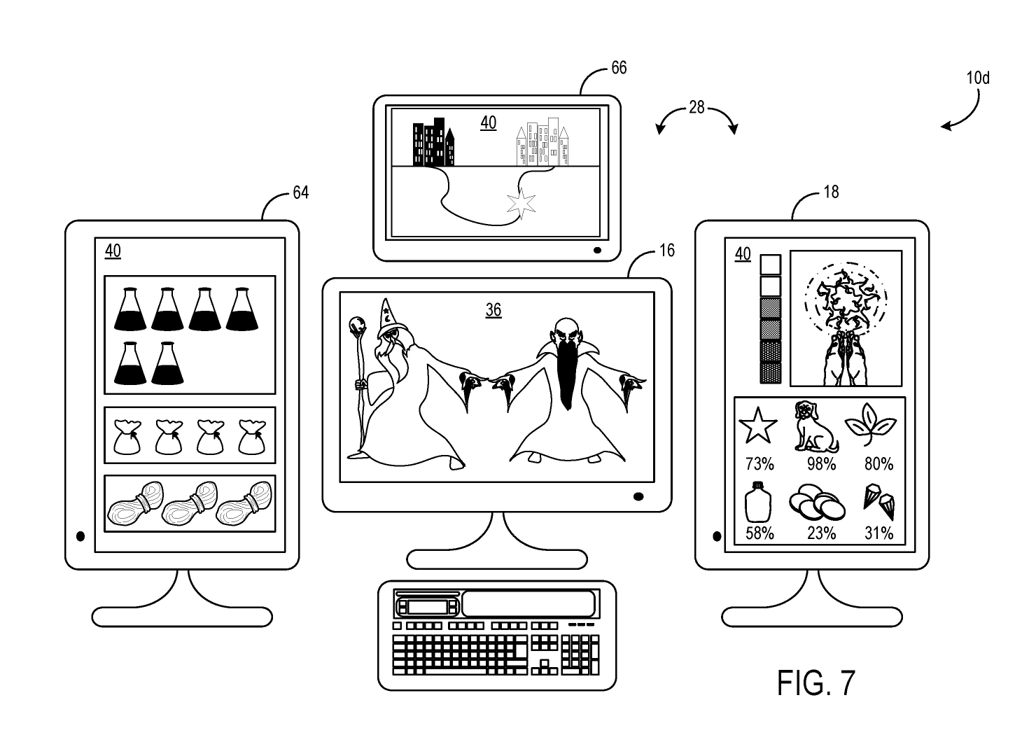

In any of the implementations described herein, the computing device 10 may be configured to include one or more displays in addition to the primary display 16 and the secondary display 18, as discussed above. An example of the computing device 10 configured as a desktop computer 10d with four displays is provided in FIG. 7. Like the example provided above in FIG. 3, the display in front of a keyboard may be configured as the primary display 16, and the display situated to the right, from the perspective of the user facing the primary display 16, may be configured as the secondary display 18. The third and fourth displays included in the computing device 10d may be configured as tertiary and quaternary displays 64, 66, respectively, and arranged to the left and above the primary display 16.

A configuration with several displays may be particularly desirable, for example, when the user is executing a gaming application program displayed in the multiple display mode 28. In an exemplary scenario illustrated in FIG. 7, the main content 36 of the GUI may be displayed on the primary display 16, and relevant information 40 related to the main content 36 may be displayed on the secondary, tertiary, and quaternary displays 18, 64, 66. As such, the user may view the main content 36 of the GUI 24 for the gaming application program on the primary display 16, while concurrently enjoying access to other relevant information 40, such as a head-up display (HUD), map, supply inventory, available armor, or the like, on the secondary, tertiary, and quaternary displays 18, 64, and 66. This configuration may permit the user to view various aspects of the gaming application program without switching between control panels, and without the main content 36 display being cluttered with distracting information, thereby enhancing the overall gaming experience.

As discussed above, it will be appreciated that the arrangement of the displays and their designations as the primary, secondary, tertiary, and quaternary displays 16, 18, 64, and 66 may be determined by the user. Additionally, while the disclosure relates mainly to application programs 22 that are viewed in a single window in the single display mode 26, it will be appreciated that the present disclosure is also applicable to application programs 22 that are configured as multiwindow applications.

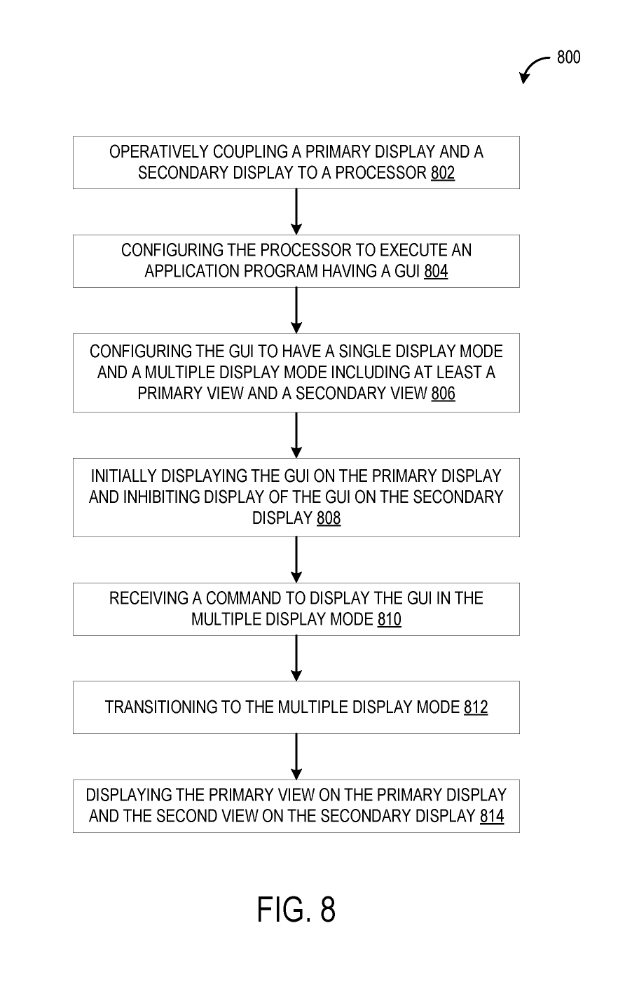

FIG. 8 shows a flow chart for an example method according to an embodiment of the present description. Method 800 may be implemented on any implementation of the computing device described above or on other suitable computer hardware.

At step 802, the method 800 may include operatively coupling a primary display and a secondary display to a processor. As described above, the computing device may be configured, for example, as a desktop computer in communication with two or more displays, as a mobile computing device having an integrated display and one or more external displays, as a mobile computing device with a housing having a first part and a second part coupled by a hinge. In the configuration of the hinged mobile computing device, the primary display may be included in the first part of the housing, and the secondary display may be included in the second part of the housing. The hinge may permit the primary and secondary displays to rotate between angular orientations from a face-to-face angular orientation to a back-to-back angular orientation.

Advancing to step 804, the method may include configuring the processor to execute an application program having a graphical user interface (GUI). Continuing from step 804 to step 806, the method may include configuring the GUI to have a single display mode and a selectively displayable multiple display mode including at least a primary view and a secondary view. This configuration allows a GUI to be viewed on a conventional computing system with a single display, but permits the user to select a multiple display mode that provides an intelligent organization of the GUI across multiple displays when the computing device is operatively coupled to two or more displays.

Proceeding from step 806 to step 808, the method may further include initially displaying the GUI on the primary display and not displaying the GUI on the secondary display, in a single display mode. Because conventional computing devices typically include a single display, the single display mode is the “default” display mode for the GUI of the application program.

Advancing from step 808 to step 810, the method may include receiving a multidisplay command to display the GUI in the multiple display mode. As described above, the multidisplay command to display the GUI in the multiple display mode may be input into the computing device in several ways. For example, a user may communicate the multidisplay command via keyboard input, pointer input, touch input from a digit, touch input from a stylus, electrical input from a switch, input from a remote device, and voice input. Further, when the computing device is configured as a hinged, mobile computing device, the multidisplay command to display the GUI in the multiple display mode may be based on a predetermined angle of the hinge.

In response to receiving the multidisplay command to display the GUI in the multiple display mode, at step 812 the method may include transitioning to the multiple display mode, and, as shown at step 814, the method may include displaying the primary view on the primary display and the secondary view on the secondary display. As described above, all or a subset of content of the launch window 27 of the GUI may be displayed in the first window on the primary display, and a subset or none of the content of the launch window 27 of the GUI may be displayed in a second window on the secondary display.

To return to the single display mode, the user may enter an exit command to stop displaying the GUI in the multiple display mode. As described above, the exit command may take the same form as, or a reverse iteration of, the multidisplay command to enter the multiple display mode. The exit command may be communicated to the computing device in several ways, such as keyboard input, pointer input, touch input from a digit, touch input from a stylus, electrical input from a switch, input from a remote device, and voice input. Examples of such communication between the user and the computing device are provided above with reference to the multidisplay command to display the GUI in the multiple display mode.

In some embodiments, the methods and processes described herein may be tied to a computing system of one or more computing devices. In particular, such methods and processes may be implemented as a computer-application program or service, an application-programming interface (API), a library, and/or other computer-program product.

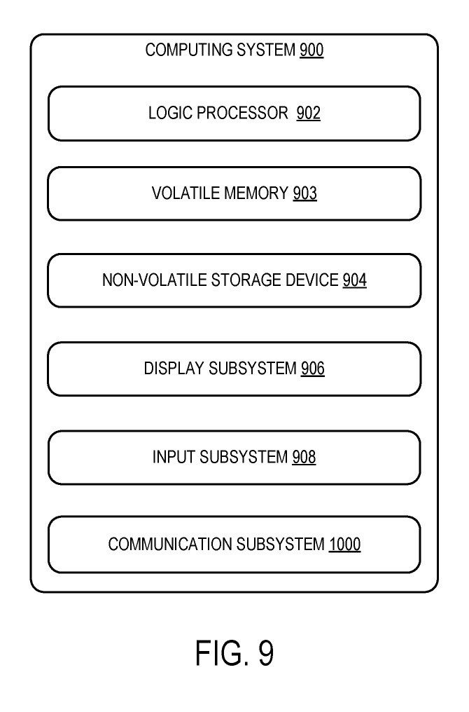

FIG. 9 schematically shows a non-limiting embodiment of a computing system 900 that can enact one or more of the methods and processes described above. Computing system 900 is shown in simplified form. Computing system 900 may embody the mobile computing device 10 of FIG. 1. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in. Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FP GAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a computing device comprising a processor, a primary display, and a secondary display. The primary display and the secondary display may each be operatively coupled to the processor. The processor may be configured to execute an application program having a graphical user interface (GUI), and the GUI may have a single display mode and a selectively displayable multiple display mode. The selectively displayable multiple display mode may include at least a primary view and a secondary view. In a single display mode, the processor may be configured to initially display the GUI on the primary display and not display the GUI on the secondary display. The processor may be configured to receive a multidisplay command to display the GUI in the multiple display mode. In response to receiving the multidisplay command, the processor may be configured to transition to the multiple display mode, and display the primary view on the primary display and the secondary view on the secondary display.

In this aspect, additionally or alternatively, the primary view may include all or a subset of content of a launch window of the GUI, and the secondary view may include a subset or none of the content of the launch window of the GUI. In this aspect, additionally or alternatively, the primary view may be displayed in a first window, and the secondary view may be displayed in a second window.

In this aspect, additionally or alternatively, the multidisplay command to display the GUI in the multiple display mode may be selected from the group consisting of keyboard input, pointer input, touch input from a digit, touch input from a stylus, electrical input from a switch, input from a remote device, and voice input. In this aspect, additionally or alternatively, an exit command to stop displaying the GUI in the multiple display mode may be selected from the group consisting of keyboard input, pointer input, touch input from a digit, touch input from a stylus, electrical input from a switch, input from a remote device, and voice input.

In this aspect, additionally or alternatively, the computing device may be configured as a desktop computing device in communication with two or more displays. In this aspect, additionally or alternatively, the computing device may be configured as a mobile computing device having an integrated display, and may be in communication with one or more external displays. In this aspect, additionally or alternatively, the computing device may be configured as a mobile computing device that further comprises a housing having a first part and a second part coupled by a hinge, the first part including the primary display and the second part including the secondary display. The hinge may be configured to permit the primary and secondary displays to rotate between angular orientations from a face-to-face angular orientation to a back-to-back angular orientation. In this aspect, additionally or alternatively, the multidisplay command to display the GUI in the multiple display mode may be based on a predetermined angle of the hinge.

In this aspect, additionally or alternatively, the computing device may comprise one or more displays in addition to the primary display and the secondary display. In this aspect, additionally or alternatively, the application program may be configured to query an application programming interface that is in communication with the processor to determine the total number of displays operatively coupled to the processor.

Another aspect provides a method for a computing device. The method may comprise operatively coupling a primary display and a secondary display to a processor, configuring the processor to execute an application program having a graphical user interface (GUI), and configuring the GUI to have a single display mode and a selectively displayable multiple display mode including at least a primary view and a secondary view. The method may further include, at the processor, in a single display mode, initially displaying the GUI on the primary display and not displaying the GUI on the secondary display, and receiving a multidisplay command to display the GUI in the multiple display mode. In response to receiving the multidisplay command, the method may further include transitioning to the multiple display mode, and displaying the primary view on the primary display and the secondary view on the secondary display.

In this aspect, additionally or alternatively, the method may further comprise displaying all or a subset of content of a launch window of the GUI in the primary view, and displaying a subset or none of the content of the launch window of the GUI in the secondary view. In this aspect, additionally or alternatively, the method may further comprise displaying the primary view in a first window, and displaying the secondary view in a second window.

In this aspect, additionally or alternatively, the method may further comprise selecting the multidisplay command to display the GUI in the multiple display mode from the group consisting of keyboard input, pointer input, touch input from a digit, touch input from a stylus, electrical input from a switch, input from a remote device, and voice input. In this aspect, additionally or alternatively, the method may further comprise selecting an exit command to stop displaying the GUI in the multiple display mode from the group consisting of keyboard input, pointer input, touch input from a digit, touch input from a stylus, electrical input from a switch, input from a remote device, and voice input.

In this aspect, additionally or alternatively, the method may further comprise configuring the computing device as a desktop computer in communication with two or more displays. In this aspect, additionally or alternatively, the method may further comprise configuring the computing device as a mobile computing device having an integrated display and one or more external displays. In this aspect, additionally or alternatively, the method may further comprise configuring the computing device as a mobile computing device with a housing having a first part and a second part coupled by a hinge, including the primary display in the first part, including the secondary display in the second part, and configuring the hinge to permit the primary and secondary displays to rotate between angular orientations from a face-to-face angular orientation to a back-to-back angular orientation.

Another aspect provides a computing device comprising a housing, a processor, a primary display, a secondary display, and an application programming interface. The housing may have a first part and a second part coupled by a hinge. The processor may be configured to execute an application program having a graphical user interface (GUI), the GUI having a single display mode and a selectively displayable multiple display mode. The selectively displayable multiple display mode may include at least a primary view and a secondary view. The primary display may be included in the first part of the housing, and the secondary display may be included in the second part of the housing. Each display may be operatively coupled to the processor. The application programming interface may be configured to communicate a quantity and arrangement of displays to the application program. In a single display mode, the processor may be configured to initially display the GUI on the primary display and not display the GUI on the secondary display, and receive a multidisplay command to display the GUI in the multiple display mode. In response to receiving the multidisplay command, the processor may be configured to transition to the multiple display mode, and display the primary view on the primary display and the secondary view on the secondary display. The primary view may be a main content of the GUI, and the secondary view may be information relevant to the main content.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a processor configured to execute an application program having a graphical user interface (GUI), the GUI having a single display mode and a selectively displayable multiple display mode including at least a primary view and a secondary view; and
a primary display and a secondary display, each display being operatively coupled to the processor;
wherein the processor is configured to:
in a single display mode,
initially display the GUI on the primary display and not display the GUI on the secondary display;
receive a multidisplay command to display the GUI in the multiple display mode; and
in response to receiving the multidisplay command,
transition to the multiple display mode; and
display the primary view on the primary display and the secondary view on the secondary display.

2. The computing device according to claim 1, wherein
the primary view includes all or a subset of content of a launch window of the GUI, and the secondary view includes a subset or none of the content of the launch window of the GUI.

3. The computing device according to claim 1, wherein
the primary view is displayed in a first window, and the secondary view is displayed in a second window.

4. The computing device according to claim 1, wherein
the multidisplay command to display the GUI in the multiple display mode is selected from the group consisting of keyboard input, pointer input, touch input from a digit, touch input from a stylus, electrical input from a switch, input from a remote device, and voice input.

5. The computing device according to claim 1, wherein
an exit command to stop displaying the GUI in the multiple display mode is selected from the group consisting of keyboard input, pointer input, touch input from a digit, touch input from a stylus, electrical input from a switch, input from a remote device, and voice input.

6. The computing device according to claim 1, wherein
the computing device is configured as a desktop computing device in communication with two or more displays.

7. The computing device according to claim 1, wherein
the computing device is configured as a mobile computing device having an integrated display, and is in communication with one or more external displays.

8. The computing device according to claim 1, wherein
the computing device is configured as a mobile computing device that further comprises a housing having a first part and a second part coupled by a hinge, the first part including the primary display and the second part including the secondary display, wherein
the hinge is configured to permit the primary and secondary displays to rotate between angular orientations from a face-to-face angular orientation to a back-to-back angular orientation.

9. The computing device according to claim 8, wherein
the multidisplay command to display the GUI in the multiple display mode is based on a predetermined angle of the hinge.

10. The computing device according to claim 1, wherein
the computing device comprises one or more displays in addition to the primary display and the secondary display.

11. The computing device according to claim 1, wherein
the application program is configured to query an application programming interface that is in communication with the processor to determine the total number of displays operatively coupled to the processor.

12. A method for a computing device, the method comprising:
operatively coupling a primary display and a secondary display to a processor;
configuring the processor to execute an application program having a graphical user interface (GUI);
configuring the GUI to have a single display mode and a selectively displayable multiple display mode including at least a primary view and a secondary view; and
the method further includes, at the processor:
in a single display mode, initially displaying the GUI on the primary display and not displaying the GUI on the secondary display;
receiving a multidisplay command to display the GUI in the multiple display mode;
in response to receiving the multidisplay command, transitioning to the multiple display mode; and
displaying the primary view on the primary display and the secondary view on the secondary display.

13. The method according to claim 12, the method further comprising:
displaying all or a subset of content of a launch window of the GUI in the primary view, and
displaying a subset or none of the content of the launch window of the GUI in the secondary view.

14. The method according to claim 12, the method further comprising:
displaying the primary view in a first window, and
displaying the secondary view in a second window.

15. The method according to claim 12, the method further comprising:
selecting the multidisplay command to display the GUI in the multiple display mode from the group consisting of keyboard input, pointer input, touch input from a digit, touch input from a stylus, electrical input from a switch, input from a remote device, and voice input.

16. The method according to claim 12, the method further comprising:
selecting an exit command to stop displaying the GUI in the multiple display mode from the group consisting of keyboard input, pointer input, touch input from a digit, touch input from a stylus, electrical input from a switch, input from a remote device, and voice input.

17. The method according to claim 12, the method further comprising:
configuring the computing device as a desktop computer in communication with two or more displays.

18. The method according to claim 12, the method further comprising:
configuring the computing device as a mobile computing device having an integrated display and one or more external displays.

19. The method according to claim 12, the method further comprising:
configuring the computing device as a mobile computing device with a housing having a first part and a second part coupled by a hinge,
including the primary display in the first part
including the secondary display in the second part, and
configuring the hinge to permit the primary and secondary displays to rotate between angular orientations from a face-to-face angular orientation to a back-to-back angular orientation.

20. A computing device comprising:
a housing having a first part and a second part coupled by a hinge;
a processor configured to execute an application program having a graphical user interface (GUI), the GUI having a single display mode and a selectively displayable multiple display mode including at least a primary view and a secondary view;
a primary display included in the first part of the housing and a secondary display included in the second part of the housing, each display being operatively coupled to the processor; and
an application programming interface configured to communicate a quantity and arrangement of displays to the application program;
wherein the processor is configured to:
in a single display mode,
initially display the GUI on the primary display and not display the GUI on the secondary display;
receive a multidisplay command to display the GUI in the multiple display mode; and
in response to receiving the multidisplay command,
transition to the multiple display mode; and
display the primary view on the primary display and the secondary view on the secondary display, wherein
the primary view is a main content of the GUI, and the secondary view is information relevant to the main content.
